(19) United States
(12) Patent Application Publication
(10) Pub. No.: US 2006/0168025 A1
(43) Pub. Date: Jul. 27, 2006

(54) Electronic communication system for user's ease of read

(76) Inventor: Anuj Kumar Jain, Raleigh, NC (US)

Correspondence Address: BINGHAM MCCUTCHEN LLP, 3000 K STREET, NW, BOX IP, WASHINGTON, DC, 20007, US

(21) Appl. No.: 11/011,687

(22) Filed: Dec. 15, 2004

(51) Int. Cl. G06F 15/16

(52) U.S. Cl. 709/206

(57) ABSTRACT

A method, computer program product, and system provides a collapsible view of electronic communication, which improves the ease of reading the communications, and reduces the time needed to read the useful parts of the communications. A method for displaying electronic communications comprises obtaining electronic communications, organizing each message thread into separate message components, displaying the message thread with nodes indicating separate message components within the message thread, and collapsing or expanding the message contents in the message thread in response to user configuration and input.

### BACKGROUND OF THE INVENTION

1. Field of the Invention

The present invention relates to electronic communication and in particular, to a collapsible view of electronic communication.

2. Description of the Related Art

As electronic communications have proliferated, their importance has greatly increased. The volume of electronic communications, such as email and other communications, has also greatly increased. However, the presentation of such communications has not significantly changed. In particular, the display of communication threads that include a number of messages and responses has not kept pace with other developments. For example, a typical electronic communication, an email communication including a message thread having a number of messages, is shown in FIG. 1. All the messages in the thread are shown at the same time, with, in this example, some indentation of text below the header to separate the messages. A purely textual view of a similar message thread displayed with indentation of text below the header is shown in FIG. 2. Another typical format, including prior message indication using the “>” character, is shown in FIG. 3. All of these formats have similar problems, namely, all messages in the thread are shown all the time.

In typical usage, a recipient of a number of email communications which continue the same thread may look at only the most recently received email communication, which includes all the messages in the thread. Conventionally, all the messages in the thread are shown all the time, which typically makes it difficult and time-consuming to read the email communication, especially if the recipient is only interested in particular messages in the thread. A need arises for a technique by which electronic communications, such as email communications and others, may be displayed that improves the ease of reading the communications, and which reduces the time needed to read the useful parts of the communication.

### SUMMARY OF THE INVENTION

The present invention provides a display of electronic communications, such as email communications and others, that improves the ease of reading the communications, and which reduces the time needed to read the useful parts of the communication.

### BRIEF DESCRIPTION OF THE DRAWINGS

Further features and advantages of the invention can be ascertained from the following detailed description that is provided in connection with the drawings described below:

FIG. 1 is an exemplary illustration of a prior art email communication.

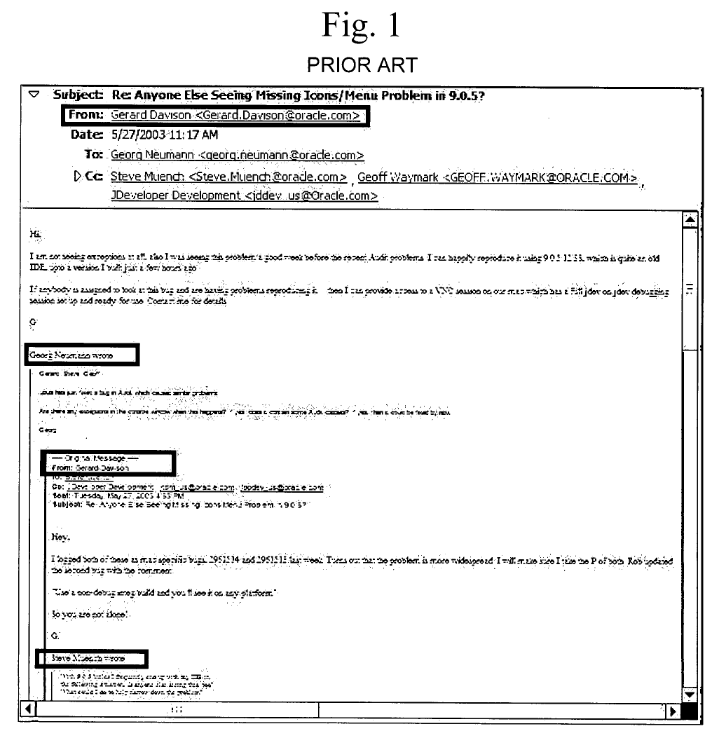

FIG. 2 is an exemplary illustration of a prior art email communication.

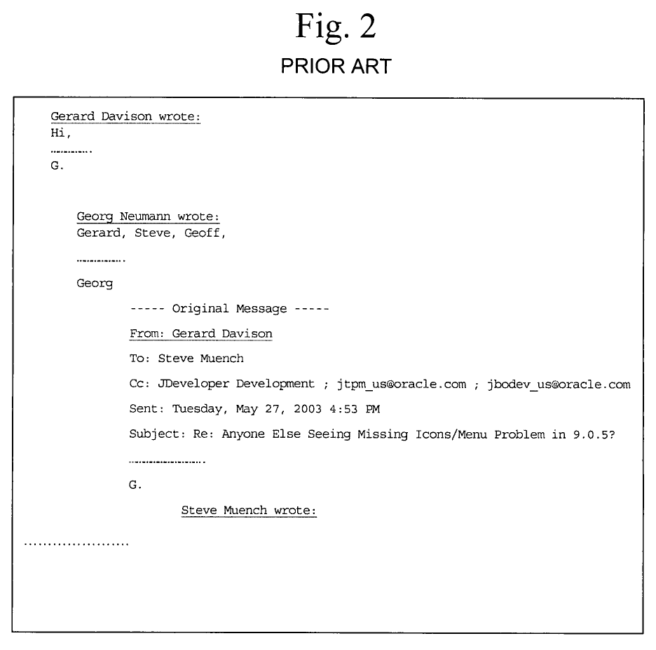

FIG. 3 is an exemplary illustration of a prior art email communication.

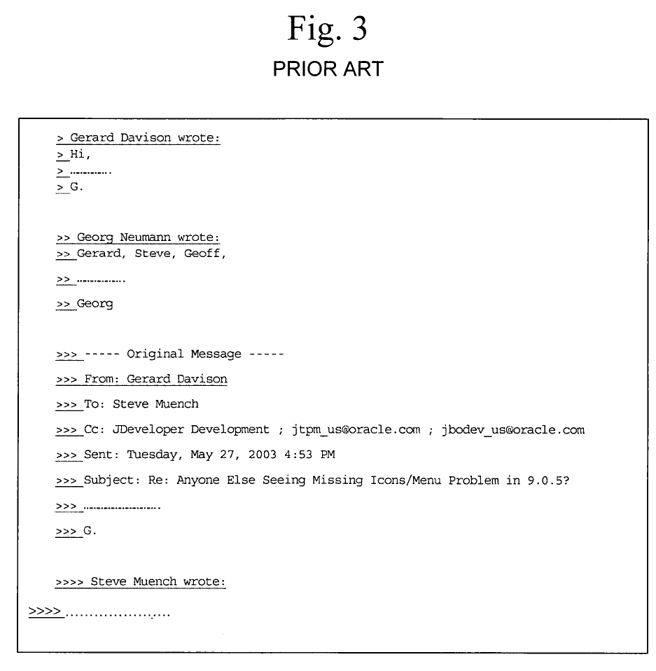

FIG. 4 is an exemplary illustration of a collapsible email communication.

FIG. 5 is an exemplary illustration of a collapsible email communication.

FIG. 6 is an exemplary illustration of a collapsible email communication.

FIG. 7 is an exemplary illustration of a collapsible email communication.

FIG. 8 is an illustration of a system for displaying electronic communications.

### DETAILED DESCRIPTION OF THE PREFERRED EMBODIMENTS

The present invention provides a display of electronic communications, such as email communications and others, that improves the ease of reading the communications, and which reduces the time needed to read the useful parts of the communication.

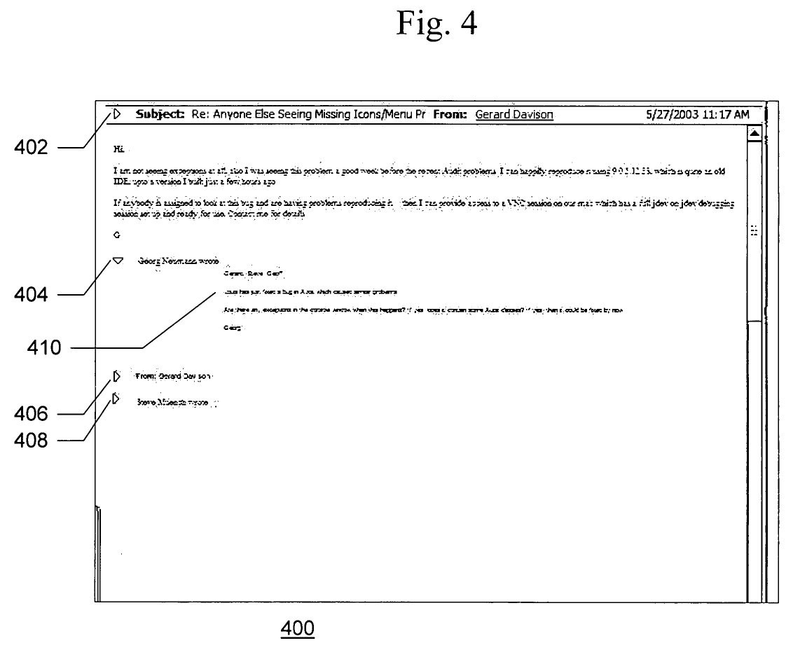

The present invention provides a client application that presents a collapsible view of electronic communication. An example 400 of such a view in the context of email communications is shown in FIG. 4. View 400 shows a typical email communication that a user might receive. View 400 includes a plurality of collapsing controls, such as collapsible arrows 402-408. Examples of a collapsing control include a collapsible arrow, a check box, or a user-configured two-graphic combination. Users can collapse and expand communication points with control selection and activation of a collapsing control. This leads to a better view of the user interface and increases usability. This also helps users consolidate and analyze information much faster. For example, collapsible arrow 404 provides the capability to collapse or expand (shown) a communication point including message 410, which is shown when the communication point is expanded. Likewise, collapsible arrows 406 and 408 provide the capability to collapse (shown) or expand communication points including messages that are not shown when the first communication point is expanded. The collapse or expansion of communication points may be triggered by control selection and activation, for example, by mouse clicks, up and down arrow selection, ok buttons, stylus taps, or keyboard entry. When a collapse or expansion is triggered, message content is hidden or revealed. A communication point may display information such as the date, time, or sender of the message content contained within the communication point.

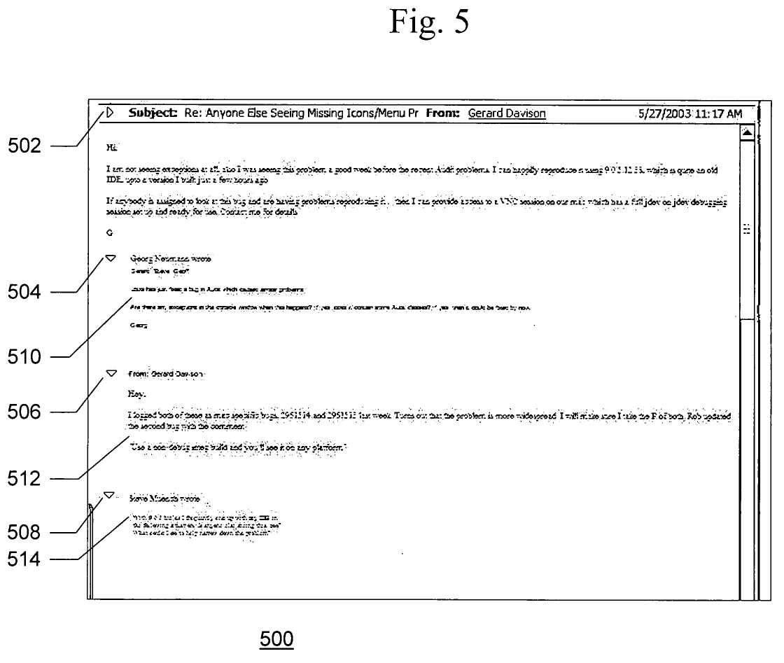

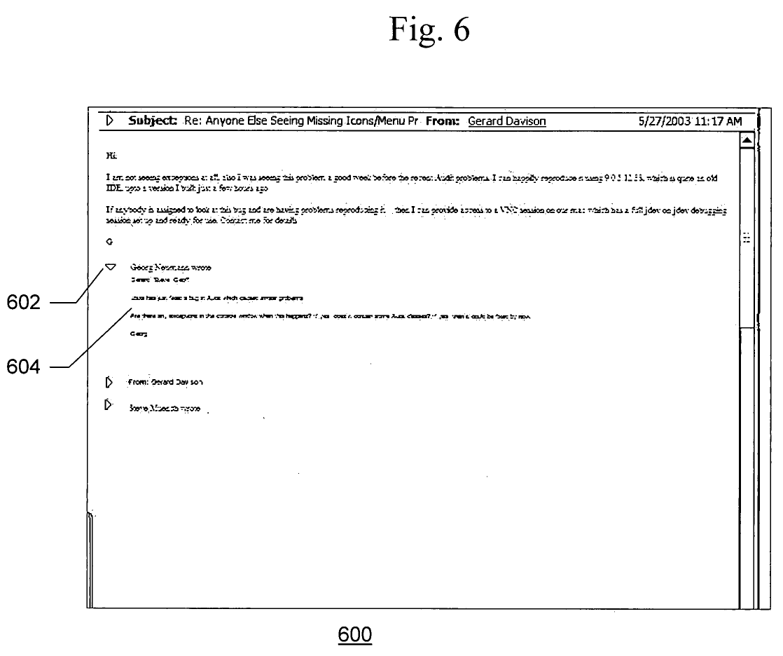

Additional examples of views 500 and 600 in the context of email communication are shown in FIGS. 5 and 6. In the example shown in FIG. 5, users can configure their client to see all nodes' 502-508 contents 510-514 as they expand nodes or, in the example shown in FIG. 6, users can configure their client to just see one expanded node 602 contents 604 at a time. Users may also expand and collapse nodes at will, so that any combination of nodes in a thread is expanded at a time.

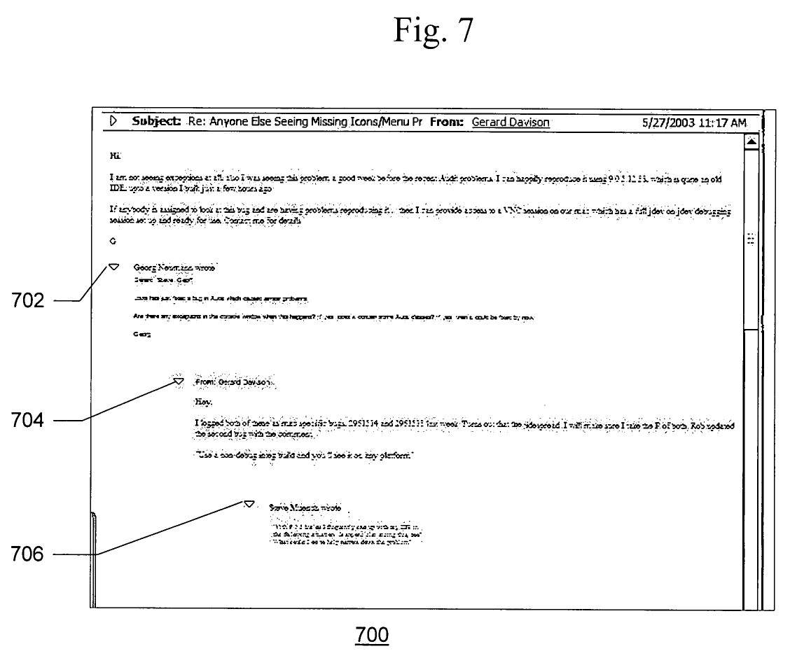

An additional feature is shown in FIGS. 4 and 6, wherein the user can configure whether they want contents of a node to appear indented under the node 410, as shown in FIG. 4, or adjacent to the node in the next line 604, as shown in FIG. 6. This feature is not to be confused with another feature, shown in FIG. 7, in which a user can further configure their application to show nested communication nodes 702, 704, and 706, rather than flat communication nodes 404, 406, and 408, shown in FIG. 4.

Additionally, the appearance of the nodes may be configured so the collapsed and expanded communication points are represented by alternative icons, for example, plus and minus signs, different colored dots, or icons of the user's choosing. The appearance of the nodes may also be configured so that communication points corresponding to different types of communication points may be displayed differently. For example, nested communication nodes 702, 704, and 706 may appear differently from each other, or communication nodes corresponding to different senders, recipients, etc. may appear differently. Differing message types within a message thread, such as text or audio messages, may also be configured to appear differently.

Additionally, message content within nodes may appear differently, for example, a text message may appear in a different font or color depending on its relationship to other nodes.

Furthermore, the client application may be configurable such that users do not have to perform control activation, such as mouse clicks, to expand nodes. This could be done by implementing a hovering mechanism wherein hovering the control indicator, such as a mouse pointer or cursor, over a node will result in expansion or collapse of a communication point.

The above-described arrangements provide the capability to organize the messages in a thread; a capability not provided by prior art arrangements. For example, a user may, by manipulating the collapsing controls, view only those messages in which they are interested, such as the newer messages, the messages from a particular party, the messages to a particular party, etc.

As an enhancement to this feature, the client application may analyze the messages in a communication and automatically organize them accordingly. For example, the communication nodes corresponding to particular senders, recipients, etc., may be linked, so that when one such node is expanded, all such nodes are expanded. Thus, expanding one message from, for example, a particular sender, would expand all messages from that sender. Also, all messages corresponding to particular senders, recipients, etc. may be organized under separate nodes, or may be displayed in specified order. This feature may itself be enhanced by the provision of semantic tags associated with each message, which provide the capability for the user to characterize each message. Such tags may include indications of whether the user agrees with the message, somewhat agrees with the message, disagrees with the message, etc. Thus, the user is provided with the capability to expand or collapse messages based on the user's characterization of the messages. The user may also configure graphic or multimedia enhancements to accompany characterization or organization of messages. Enhancements may include changes in font, font size, font color, node appearance, or audio cues such as beeps.

In addition to collapsible message content, header information may also be collapsed and expanded. In FIGS. 4 and 5, it would be possible to expand header nodes 402 and 502 to see additional header information. In the example of a collapsed state shown in FIG. 4, only the beginning of the “Subject” line, the sender information, and the date and time the message was received is visible. If a user expanded the header node, additional information such as return path, message id, sending email program, content type, recipient information, etc. may be displayed, as well as the subject line, sender, and date and time information.

Additionally, the amount of information displayed when the header node is expanded or collapsed may be configured. For example, the user can configure whether they only want the sender information displayed when the header node is expanded, show all available header information, or show a specific subset of headers selected by the user. The user may also configure the header node so that it is not collapsible, but only displays selected header information. The configuration of the behavior of the header node would not affect the configuration of message node behavior. However, the same visual and audio enhancements available to configure message nodes would be available to configure header nodes. The display of header information could also be configured to change depending on message or header content. For example, the amount of header information displayed upon collapse or expansion could be configurable on a per-sender basis.

Preferably, all of the above-described features are configurable as desired by the user. This provides the maximum flexibility and usefulness in organizing and viewing the message content. Methods of configuring the application may include a visual interface, a configuration file, or a command-line flag.

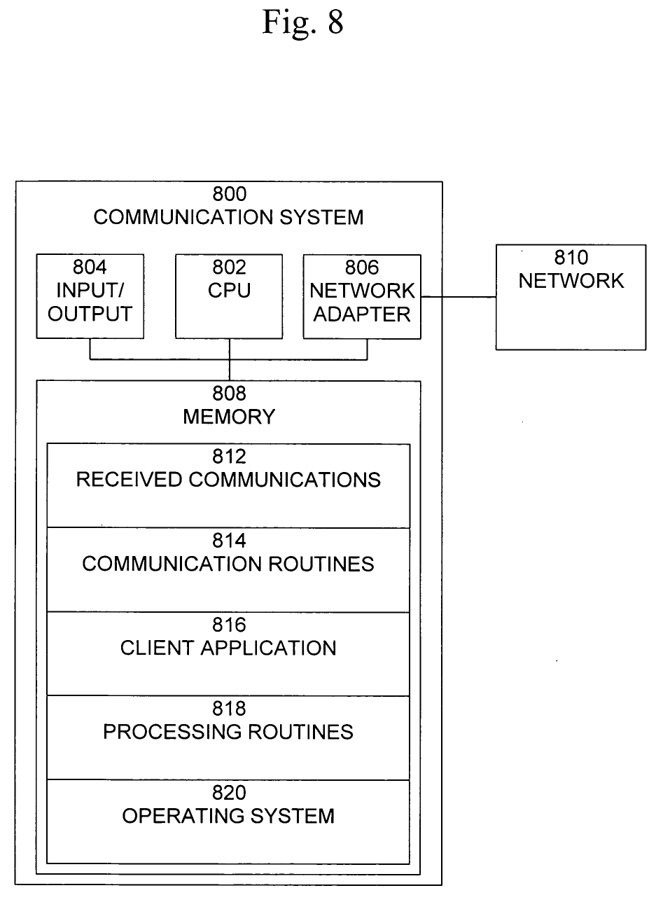

An exemplary block diagram of a communication system 800, in which the present invention may be implemented, is shown in FIG. 8. System 800 may be a programmed general-purpose computer system, such as a personal computer, workstation, server system, and minicomputer or mainframe computer, or system 800 may be a special-purpose device, such as a personal digital assistant, portable email device, mobile telephone, etc. System 800 includes processor (CPU) 802, input/output circuitry 804, network adapter 806, and memory 808. CPU 802 executes program instructions in order to carry out the functions of the device, including those of the present invention. Typically, CPU 802 is a microprocessor, such as an INTEL PENTIUM® processor, but may also be a minicomputer or mainframe computer processor. Input/output circuitry 804 provides the capability to input data to, or output data from, computer system 800. For example, input/output circuitry may include input devices, such as keyboards, keypads, mice, touchpads, trackballs, scanners, microphones, etc., output devices, such as video adapters, monitors, liquid crystal displays (LCDs), printers, speakers, etc., and input/output devices, such as, modems, etc. Network adapter 806 interfaces system 800 with network 810. Network 810 may be any standard local area network (LAN) or wide area network (WAN), such as Ethernet, Token Ring, the Internet, or a private or proprietary LAN/WAN. Likewise, for mobile systems, network 810 may be a wireless communication network, such as a Wi-Fi network, a PCS network, a GSM network, etc.

Memory 808 stores program instructions that are executed by, and data that are used and processed by, CPU 802 to perform the functions of the present invention. Memory 808 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 808 includes a data, such as received communications 812, and program instructions, such as communication routines 814, client application 816, processing routines 818, and operating system 820. Received communications 812 include communications that have been received by system 800, such as email communications, internet chat communications, newsgroup communications, voice communications, image or video communications, etc. Communication routines 814 include software that provides system 800 with the capability to receive received communications 812, as well as to transmit communications from system 800. Client application 816 includes software that displays received communications 812 to the user, in accordance with the present invention. Processing routines 818 include software that performs other functions (if any) of system 800. Operating system 820 provides overall system functionality.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for displaying electronic communications, the method comprising:
obtaining electronic communications comprising at least one message thread;
organizing each message thread into separate message components;
displaying a message thread with nodes, the nodes indicating separate message components within the message thread; and
collapsing or expanding of message contents in the message thread in response to configuration.

2. The method of claim 1, where the organization, collapse, expansion, or indentation of the nodes or the message contents is configurable.

3. The method of claim 1, where the collapse or expansion of the header node is configurable.

4. The method of claim 1, where the behavior of nodes in response to control selection and activation is configurable.

5. The method of claim 1, where the appearance of the nodes is configurable.

6. The method of claim 5, where the display of the nodes is configurable so subsequent nodes are displayed differently.

7. The method of claim 6, where the behavior of succeeding nodes is configurable so that they are collapsed or expanded depending on the state of the preceding nodes and the organization of the thread.

8. The method of claim 1, where the method of analysis by which the message threads are organized is configurable.

9. The method of claim 1, where the configuration that triggers hiding or not hiding message components is user input or a preference file.

10. The method of claim 1, where the electronic communications include one of an email message, a newsgroup message, a text message, a voicemail message, a video communication, or an image communication.

11. The method of claim 1, where the method steps are performed on a personal computer, workstation, server system, minicomputer, mainframe computer, personal digital assistant, portable email device, or mobile telephone.

12. A system for displaying electronic communications, the system comprising:
a processor operable to execute computer program instructions;
an adapter operable for communicating with a network; and
software operational on the electronic device for performing the steps of:
obtaining electronic communications comprising at least one message thread;
organizing each message thread into separate message components;
displaying the message thread with nodes, the nodes indicating separate message components within the message thread; and
collapsing and expanding of message components in the message thread in response to configuration.

13. The system of claim 12, where the organization, collapse, expansion, or indentation of the nodes or the message contents is configurable.

14. The system of claim 12, where the collapse or expansion of the header node is configurable.

15. The system of claim 12, where the behavior of nodes in response to control selection and activation is configurable.

16. The system of claim 12, where the appearance of the nodes is configurable.

17. The system of claim 16, where the display of the nodes is configurable so subsequent nodes are displayed differently.

18. The system of claim 17, where the behavior of succeeding nodes is configurable so that they are collapsed or expanded depending on the state of the preceding nodes and the organization of the thread.

19. The system of claim 12, where the method of analysis by which the message threads are organized is configurable.

20. The system of claim 12, where the configuration that triggers hiding or not hiding message components is user input or a preference file

21. The system of claim 12, where the electronic communications include one of an email message, a newsgroup message, a text message, a voicemail message, a video communication, or an image communication.

22. The system of claim 12, where the system is a personal computer, workstation, server system, minicomputer, mainframe computer, personal digital assistant, portable email device, or mobile telephone.

23. A computer program product for displaying electronic communications, the program product comprising:
a computer readable medium;
computer program instructions recorded on the computer readable medium, executable by a processor, for performing the steps of
obtaining electronic communications comprising at least one message thread;
organizing each message thread into separate message components;
displaying the message thread with nodes, the nodes indicating separate message components within the message thread; and
collapsing of message components in the message thread in response to configuration.

24. The computer program product of claim 23, where the organization, expansion, or indentation of the nodes or the message contents is configurable.

25. The computer program product of claim 23, where the collapse or expansion of the header node is configurable.

26. The computer program product of claim 23, where the behavior of nodes in response to control selection and activation is configurable.

27. The computer program product of claim 23, where the appearance of the nodes is configurable.

28. The computer program product of claim 27, where the display of the nodes is configurable so subsequent nodes are displayed differently.

29. The computer program product of claim 28, where the behavior of succeeding nodes is configurable so that they are collapsed or expanded depending on the state of the preceding nodes and the organization of the thread.

30. The computer program product of claim 23, where the method of analysis by which the message threads are organized is configurable.

31. The computer program product of claim 23, where the configuration that triggers hiding or not hiding message components is user input or a preference file.

32. The computer program product of claim 23, where the electronic communications include one of an email message, a newsgroup message, a text message, a voicemail message, a video communication, or an image communication.

33. The computer program product of claim 23, where the program product is executed on a personal computer, workstation, server system, minicomputer, mainframe computer, personal digital assistant, portable email device, or mobile telephone.
